(19) United States
(12) Patent Application Publication
(10) Pub. No.: US 2014/0168699 A1
(43) Pub. Date: Jun. 19, 2014

(54) PRINTING SYSTEM, PRINTING APPARATUS, INFORMATION PROCESSING APPARATUS, AND PRINTING CONTROL METHOD

(71) Applicant: CANON KABUSHIKI KAISHA, Tokyo (JP)

(72) Inventor: Naoki Morita, Kawasaki-shi (JP)

(21) Appl. No.: 14/103,317

(22) Filed: Dec. 11, 2013

(30) Foreign Application Priority Data
Dec. 13, 2012 (JP) 2012-272337

(51) Int. Cl. G06F 3/12

(52) U.S. Cl. CPC G06F 3/1296
USPC 358/1.15

(57) ABSTRACT

A printing system includes a storage unit for storing permission information indicating that a user permits printing to be executed even if it is determined that there is a lack of a recording material. The printing system executes printing if it is determined that there is the lack of the recording material and the permission information indicating that the user who instructs printing permits printing to be executed, is stored. The printing system does not execute printing in a state where it is determined that there is the lack of the recording material if the permission information indicating that the user who instructs printing permits printing to be executed, is not stored.

### BACKGROUND OF THE INVENTION

1. Field of the Invention

The present invention relates to a printing control method for performing printing by using a recording material.

2. Description of the Related Art

A printing apparatus for performing printing by using a recording material determines whether a recording material remains within the apparatus, with use of a measuring unit such as an optical sensor. If the printing apparatus determines that the recording material does not remain, the printing apparatus displays state information indicating that the recording material does not remain.

Actually, however, a small amount of the recording material may remain depending on the accuracy of the measuring unit even if it is determined that the recording material does not remain. Some users may desire the continuation of printing at the risk of fading away of print even if it is determined that the recording material does not remain.

To respond to this desire, a printing apparatus which continues printing according to user's instructions even if it is determined that the recording material does not remain has been discussed in Japanese Patent Application Laid-Open No. 2012-189693. According to Japanese Patent Application Laid-Open No. 2012-189693, even if it is determined that the recording material does not remain, the printing apparatus executes printing if a toner excess-usage mode is turned on.

If the printing apparatus is being used by a plurality of users, the following problem arises. That is, one user (hereinafter referred to as a user A) instructs a printing apparatus to execute printing even if it is determined that the recording material does not remain, thereafter, the other user (hereinafter referred to as a user B) may acquire a print whose quality does not satisfy the user B′ desire by using the printing apparatus.

Let us assume that it is determined that the recording material does not remain while the printing apparatus is executing printing according to printing instructions from the user A, for example. The user A instructs the printing apparatus to transition to a state where printing is executed (hereinafter referred to as a continuous printing state) at the risk of fading away of print even in a state where it is determined that the recording material does not remain. Then, the printing apparatus continues printing according to the instructions. Thereafter, if the user B instructs the printing apparatus to perform printing, the printing apparatus in the continuous printing state executes printing even in a state where it is determined that the recording material does not remain. As a result, fading of print occurs which provides the user with print whose quality does not satisfy the user.

If each user can switch an apparatus status and determine whether print is to be executed in a state where it is determined that the recording material does not remain, user-friendliness is improved.

### SUMMARY OF THE INVENTION

According to an aspect of the present invention, a printing system which performs printing using a recording material stored in a storing unit configured to store the recording material includes a printing unit configured to perform printing using the recording material stored in the storing unit, a storage unit configured to store permission information indicating that a user permits printing to be executed even if it is determined that the storing unit lacks the recording material, and a control unit configured to cause the printing unit to perform printing if it is determined that the storing unit lacks the recording material and the permission information indicating that the user who instructs printing permits printing to be executed is stored, wherein the control unit does not cause the printing unit to perform printing in a state where it is determined that the storing unit lacks the recording material, if it is determined that the storing unit lacks the recording material and the permission information indicating that the user who instructs printing permits printing to be executed, is not stored.

According to another aspect of the present invention, a printing apparatus which performs printing using a recording material stored in a storing unit configured to store the recording material includes a printing unit configured to perform printing using the recording material stored in the storing unit, a storage unit configured to store permission information indicating that a user permits printing to be executed even if it is determined that the storing unit lacks the recording material, and a control unit configured to cause the printing unit to perform printing if it is determined that the storing unit lacks the recording material and the permission information indicating that the user who instructs printing permits printing to be executed, is stored, wherein the control unit does not cause the printing unit to perform printing in a state where it is determined that the storing unit lacks the recording material, if it is determined that the storing unit lacks the recording material and the permission information indicating that the user who instructs printing permits printing to be executed, is not stored.

According to yet another aspect of the present invention, an information processing apparatus communicable with a printing apparatus which performs printing using a recording material includes a storage unit configured to store permission information indicating that a user permits printing to be executed even if it is determined that the printing apparatus lacks the recording material and a control unit configured to cause the printing apparatus to perform printing if it is determined that the printing apparatus lacks the recording material and the permission information indicating that the user who instructs printing permits printing to be executed, is stored, wherein the control unit does not cause the printing apparatus to perform printing in a state where it is determined that the printing apparatus lacks the recording material, if it is determined that the printing apparatus lacks the recording material and the permission information indicating that the user who instructs printing permits printing to be executed, is not stored.

According to still yet another aspect of the present invention, an information processing apparatus communicable with a printing apparatus which performs printing using a recording material includes a determination unit configured to determine whether print setting conforms to a predetermined condition and a control unit configured to cause the printing apparatus to perform printing if it is determined that the printing apparatus lacks the recording material and the print setting does not conform to the predetermined condition, wherein the control unit does not cause the printing apparatus to perform printing in a state where it is determined that the printing apparatus lacks the recording material, if it is determined that the printing apparatus lacks the recording material and the print setting conforms to the predetermined condition.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a printing system according to the present exemplary embodiment.

FIG. 2 illustrates the hardware configuration of the information processing apparatuses.

FIG. 3 illustrates a hardware configuration of a printing apparatus.

FIG. 4 illustrates an example of a software program executed by the control unit of the information processing apparatuses.

FIG. 5 describes a basic concept for determining whether to continuously use a toner cartridge running short of toner for each user by switching an apparatus status.

FIG. 6 illustrates a flow chart indicating a basic concept of a printing control processing executed by the printing system.

FIG. 7 illustrates a table for managing a continuous use flag and a table for managing a continuous use permission flag.

FIG. 8 illustrates a flow chart indicating the printing control processing executed by the printing apparatus.

FIG. 9 illustrates a flow chart indicating the printing control processing executed by the printing apparatus.

FIG. 10 is an example of a screen for inquiring whether the user permits the continuous use of the toner cartridge.

FIG. 11 is an example of a screen for inquiring whether the user permits the continuous use of the toner cartridge.

FIG. 12 is a flow chart illustrating the printing control processing executed by the information processing apparatuses.

FIG. 13 is a flow chart illustrating the printing control processing executed by the printing apparatus.

FIG. 14 is a flow chart illustrating the printing control processing executed by the information processing apparatuses.

FIG. 15 illustrates a cross section of the printing apparatus.

### DESCRIPTION OF THE EMBODIMENTS

Various exemplary embodiments, features, and aspects of the invention will be described in detail below with reference to the drawings.

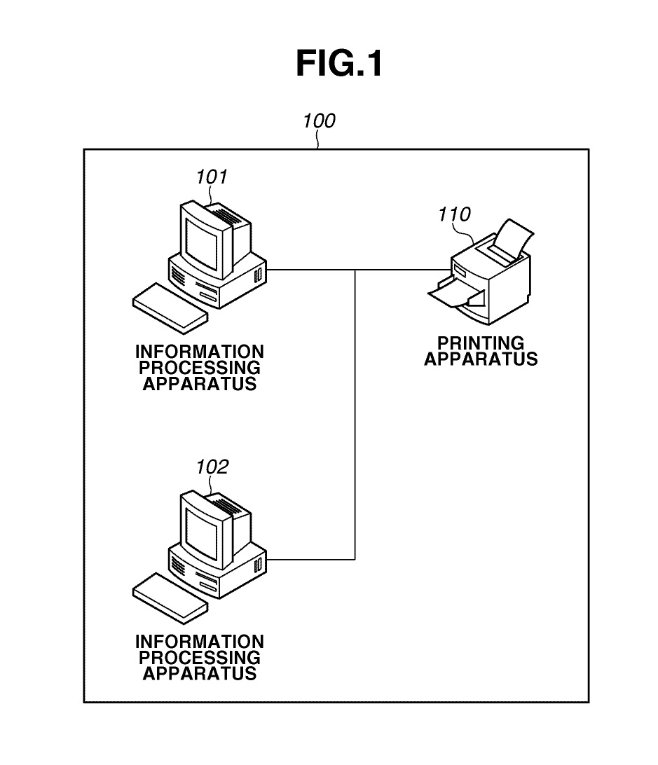

FIG. 1 illustrates a printing system 100 according to the present exemplary embodiment. The printing system 100 includes information processing apparatuses 101 and 102 and a printing apparatus 110. The information processing apparatuses 101 and 102 can communicate with the printing apparatus 110 via a universal serial bus (USB) interface or network. The network may be a wire or a wireless network. In the present exemplary embodiment, two information processing apparatuses are used, however, the number of the information processing apparatuses is not limited to two.

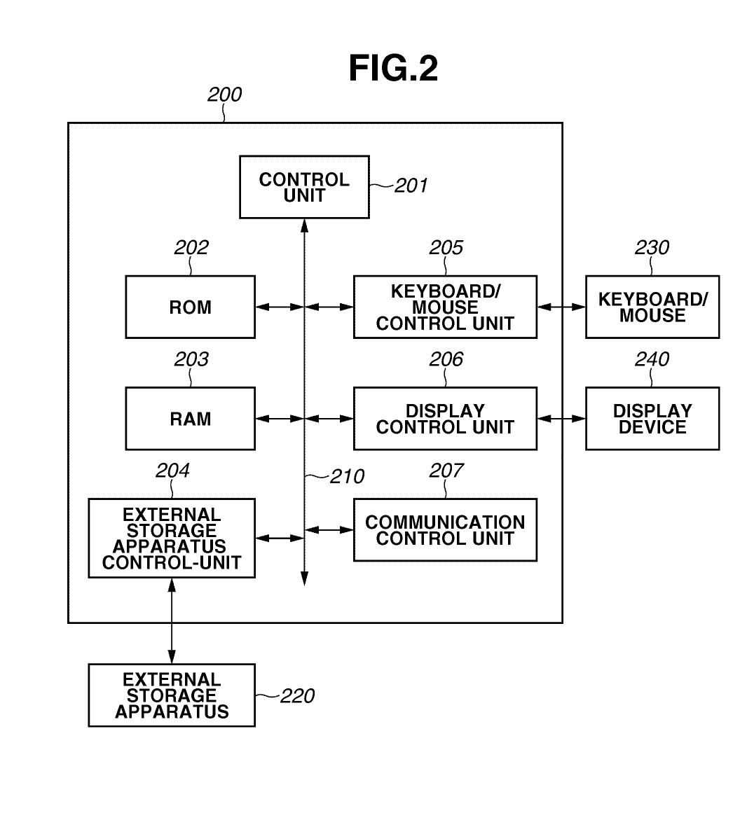

FIG. 2 illustrates the hardware configuration of the information processing apparatuses 101 and 102. An information processing apparatus body 200 includes a control unit 201, a read only memory (ROM) 202, a random access memory (RAM) 203, an external storage apparatus control unit 204, a keyboard/mouse control unit 205, a display control unit 206, a communication control unit 207, and a system bus 210. The information processing apparatus further includes an external storage apparatus 220 acting as an external storage apparatus and a keyboard/mouse 230 as an input and output device and a display device 240.

The control unit 201 is a central processing unit (CPU) or a micro processing unit (MPU) and executes various types of processing according to a control program. The ROM 202 is a nonvolatile storage device and stores various control programs and initial setting values. The RAM 203 is a volatile storage device and functions as a work memory used for the control unit 201 executing the various types of processing. The programs stored in the ROM 202 and the external storage apparatus 220 are transferred to the RAM 203 and executed by the control unit 201.

The external storage apparatus control unit 204 controls the input and the output of information to and from the external storage apparatus 220 according to instructions from the control unit 201. The external storage apparatus 220 is a storage device such as a hard disk, a compact disk (CD), a digital versatile disk (DVD). The keyboard/mouse control unit 205 monitors input from the keyboard/mouse 230 and transfers input information to the control unit 201. The display control unit 206 controls the display of information on the display device 240 according to instructions from the control unit 201. The display device 240 is a device such as a liquid crystal display and displays information (including a screen).

The communication control unit 207 controls communication via a universal serial bus (USB) or a network according to instructions from the control unit 201. The communication control unit 207 further includes a connector for connecting the communication control unit 207 to the USB or the network.

The system bus 210 is a bus connected to the control unit 201, the ROM 202, the RAM 203, the external storage apparatus control unit 204, the keyboard/mouse control unit 205, the display control unit 206, and the communication control unit 207.

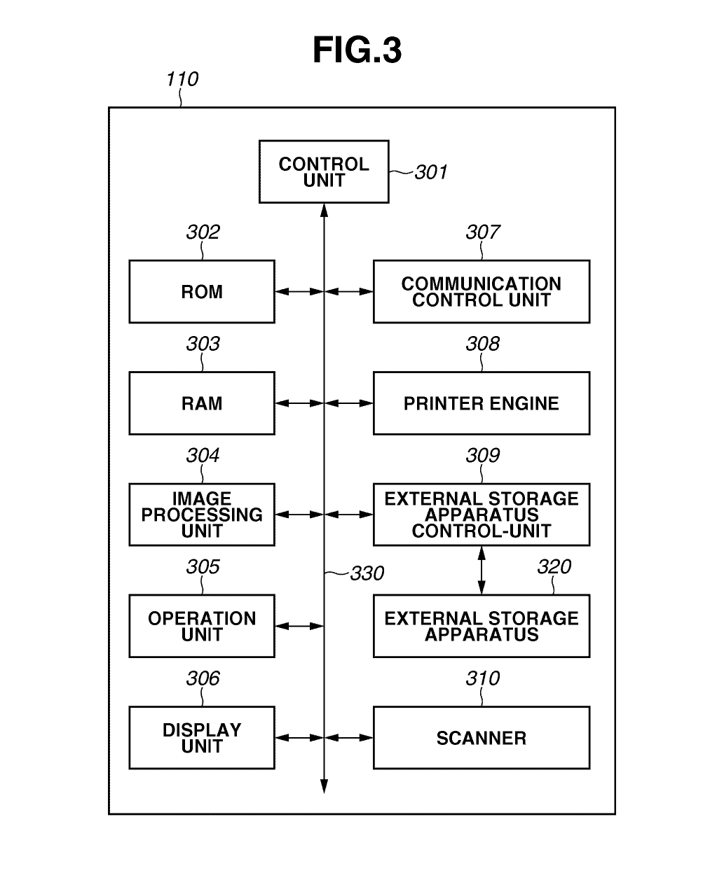

FIG. 3 illustrates the hardware configuration of the printing apparatus 110. The printing apparatus 110 includes a control unit 301, a ROM 302, a RAM 303, an image processing unit 304, an operation unit 305, a display unit 306, a communication control unit 307, a printer engine 308, an external storage apparatus control unit 309, a scanner 310, an external storage apparatus 320, and a system bus 330.

The control unit 301 is a CPU or a MPU and executes various types of processing according to a control program. The control unit 301 performs a serial communication with a printer engine 308 to transmit image data to the printer engine 308. The printer engine 308 prints the image indicated by the image data on a sheet. The ROM 302 is a nonvolatile storage device and stores various control programs and initial setting values. The RAM 303 is a volatile storage device and functions as a work memory used for the control unit 301 executing the various types of processing. The programs stored in the ROM 302 and the external storage apparatus 320 are transferred to the RAM 303 and executed by the control unit 301.

The image processing unit 304 is an integrated circuit such as an application specific integrated circuit (ASIC) and executes various types of image processing according to instructions from the control unit 301.

The operation unit 305 is an input device such as a touch panel and a button. The control unit 301 monitors input from the operation unit 305 and acquires input information. A display unit 306 is a display device such as a light emitting diode (LED) or a liquid crystal display (LCD) and displays information according to instructions from the control unit 301. A touch panel display may serve as both the operation unit 305 and the display unit 306.

The communication control unit 307 controls communication via the USB or a network according to instructions from the control unit 301. The communication control unit 307 further includes a connector for connecting the communication control unit 307 to the USB or the network.

The printer engine 308 prints an image on a sheet based on the image data. The details of the printer engine 308 are described below. The scanner 310 reads an image on a document and generates image data. If the printing apparatus 110 includes the scanner 310, the printing apparatus 110 provides a copy function. The copy function causes the scanner 310 to read an image on a document, and the printer engine 308 to print the image on a sheet based on the image data generated by the scanner 310. If the printing apparatus 110 does not provide the copy function, the scanner 310 does not need to be included in the printing apparatus 110.

The external storage apparatus control unit 309 controls the input and the output of information to and from the external storage apparatus 320 according to instructions from the control unit 301. The external storage apparatus 320 is a storage device such as a hard disk and others.

The system bus 330 is a bus connected to the control unit 301, the ROM 302, the RAM 303, the image processing unit 304, the operation unit 305, the display unit 306, the communication control unit 307, the printer engine 308, the external storage apparatus control unit 309, and the scanner 310. A signal line (not illustrated) is also provided between the control unit 301 and the printer engine 308.

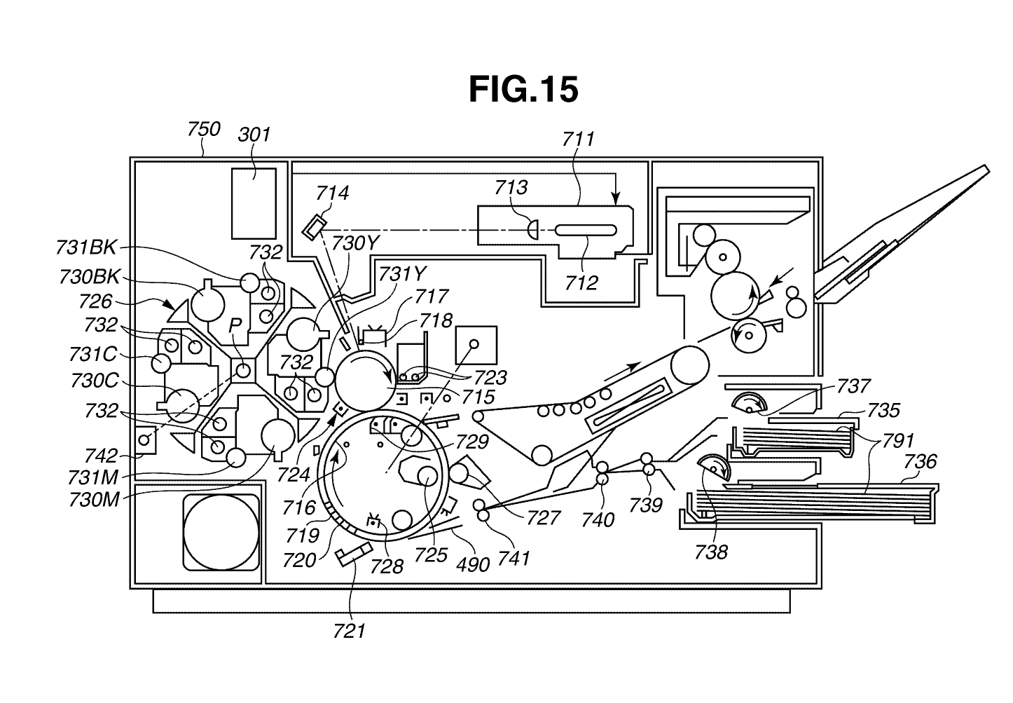

FIG. 15 illustrates a cross section of the printing apparatus 110. FIG. 15 mainly illustrates an internal structure of the printer engine 308 and a rotary development rotary color-laser-printer. Toner is used as the recording material for printing. A toner cartridge is used as a storage unit for storing the recording material.

A scanner 711 includes a laser output unit (not illustrated) for converting an image signal from the control unit 301 into an image signal, an octahedron polygon mirror 712, a motor (not illustrated) for rotating the octahedron polygon mirror 712, and an f/θ lens (imaging lens) 713. A laser beam output from the laser output unit is reflected by a facet of the polygon mirror 712, passes through the f/θ lens 713 and a reflection mirror 714, and linearly scans (raster scan) the face of a photosensitive drum 715.

The photosensitive drum 715 rotates in the direction indicated by an arrow illustrated in the figure. With the rotation of the drum, an electrostatic latent image is formed corresponding to the image indicated by the image signal on the surface of the photosensitive drum 715. Around the periphery of the photosensitive drum 715 are arranged a primary charging device 717, a whole surface exposure lamp 718, a cleaner unit 723 for collecting toner (residual toner) which is not transferred to the sheet, and a pre-transfer charger 724.

A development unit 726 is configured to develop the electrostatic latent image formed on the surface of the photosensitive drum 715. The development unit 726 has a configuration described below. Toner cartridges 730C, 730M, 730Y, and 730BK store toner as a developer. The remaining amount of toner in the toner cartridge is measured by a toner remaining amount sensor (not illustrated). Development sleeves 731C, 731M, 731Y, and 731BK contact the photosensitive drum 715 to perform development using the developer. A screw 732 transfers the developer stored in the toner cartridges 730C, 730M, 730Y, and 730BK to the development sleeves 731C, 731M, 731Y, and 731BK respectively. In other words, the cyan, magenta, yellow, and black developers are used to form a toner image on the photosensitive drum 715. The toner cartridges, the development sleeves, and the screws are arranged around a center axis P of the development unit 726. The characters, Y, M, C, and BK, represent colors different from one another. More specifically, the C, M, Y, and BK represent cyan, magenta, yellow, and black respectively.

A cover 750 is openable and closable. The user opens the cover 750 to replace the toner cartridge. The toner cartridge immediately underlying the cover 750 can be removed. Hereinafter, a position immediately underlying the cover 750 is referred to as a “toner cartridge replaceable position.” In FIG. 15, the toner cartridge 730BK lies in the toner cartridge replaceable position. The toner cartridges 730C, 730M, 730Y, and 730BK are rotated with the axis P serving as a center to move each toner cartridge to the toner cartridge replaceable position, allowing each toner cartridge to be replaced.

A position sensor 742 detects a rotation position of the development unit 726. If a yellow toner image is formed on the photosensitive drum 715, a motor (not illustrated) rotates the development unit 726 with the axis P serving as a center to cause the development sleeve 731Y to contact the photosensitive drum 715. FIG. 15 illustrates the above state. If a magenta toner image is formed, the motor rotates the development unit 726 with the axis P as a center to cause the development sleeve 731M to contact the photosensitive drum 715. The same holds true for a case where a cyan or a black toner image is formed.

A transfer drum 716 transfers the toner image formed on the photosensitive drum 715 to a sheet. An actuator plate 719 detects the movement position of the transfer drum 716. A position sensor 720 closely contacts the actuator plate 719 to detect that the transfer drum 716 has moved to the home position.

Around the periphery of the transfer drum 716 are arranged the actuator plate 719, the position sensor 720, a transfer drum cleaner unit 725, a paper pressing roller 727, a static eliminator 728, and a transfer charger 729.

Sheet cassettes 735 and 736 store sheets 791. For example, the sheet cassette 735 stores an A-4 size sheet and the sheet cassette 736 stores an A-3 size sheet. When the sheet is fed and conveyed, sheet feeding roller 737 and 738 feed sheets from the sheet cassettes 735 and 736 respectively. Timing rollers 739, 740, and 741 control timing at which the sheet is fed and conveyed. The sheet is guided to a paper guide 490 via the timing rollers 739, 740, and 741. The leading edge of the sheet, while being carried by a gripper 721, is wound around the transfer drum 716. Selection of either the sheet cassette 735 or the sheet cassette 736 is determined by instructions of the control 301. Only the sheet feeding roller corresponding to the selected sheet cassette is rotated.

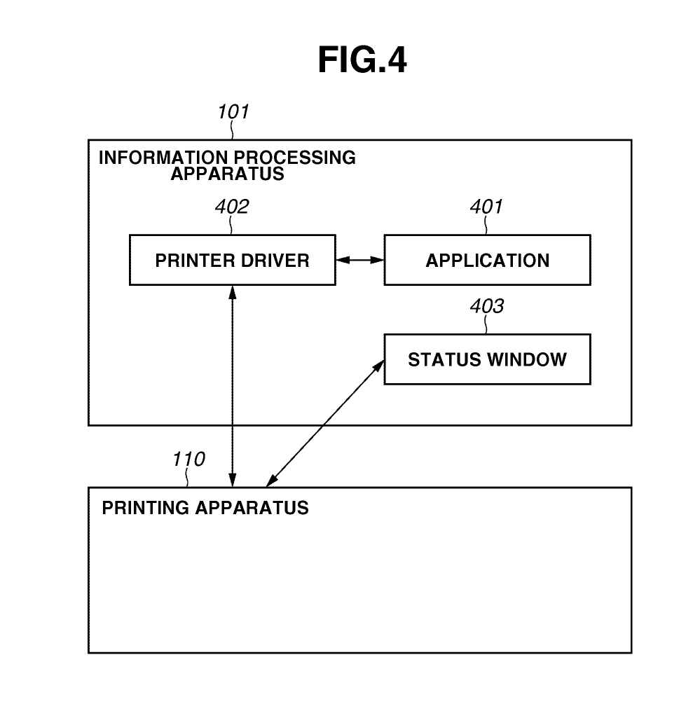

FIG. 4 illustrates an example of a software program executed by the control unit 201 of the information processing apparatuses 101 and 102.

An application 401 is the one that is used mainly by a user. The application 401 is a document generation application and a spreadsheet application, for example. The user issues instructions for printing by the application 401.

When the user issues instructions for printing, a printer driver 402 provides the user with a user interface for print setting and issues a print job to the printing apparatus 110 according to the print data received from the application 401 and the print setting.

A status window 403 acquires state information from the printing apparatus 110 and displays the state information. The status window 403 gives various orders to the printing apparatus 110 according to the operation of the user.

The control unit 301 of the printing apparatus 110 communicates with the printer driver 402 or the status window 403 via the communication control unit 307 and executes processing according to communication contents. For example, the control unit 301 controls printing based on the print job transmitted by the printer driver 402. The control unit 301 controls the printing apparatus 110 in accordance with instructions transmitted by the status window 403. The control unit 301 transmits state information to the printer driver 402 or the status window 403 via the communication control unit 307.

The control unit 301 measures a remaining amount of toner based on information from one or more sensors of the printer engine 308. The remaining amount of toner is measured for each toner cartridge. The control unit 301 determines whether the toner cartridge is out of toner based on the measured remaining amount of toner.

However, it is sometimes impossible to detect whether no toner remains in the toner cartridge depending on the accuracy of the sensor. In other words, even if it is determined that the toner cartridge is out of toner or it is determined that the remaining amount of toner is less than the predetermined amount, actually however, a small amount of toner enough for printing a few pages may remain in the toner cartridge. Some users may want to use the toner cartridge at the risk of fading away of print. In this case, the user can select the continuous use of the toner cartridge which is running out of toner. Hereinafter, that is referred to as “continuous use of the toner cartridge.” In the following, the toner cartridge determined as running out of toner is referred to as “toner cartridge running short of toner” or “toner cartridge running short of toner.”

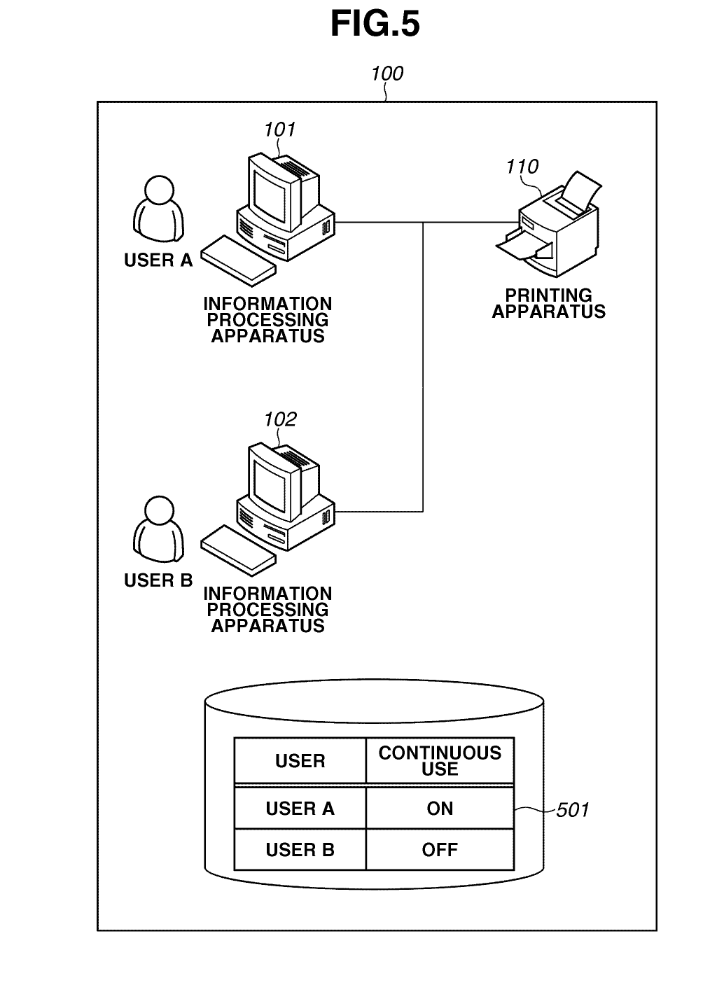

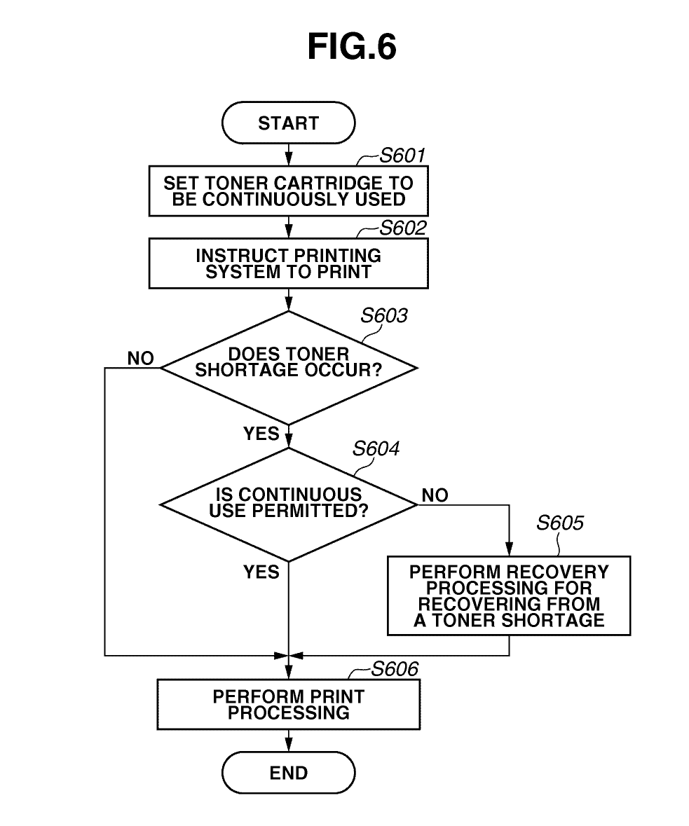

FIGS. 5 and 6 describe a basic concept for switching and determining for each user whether the toner cartridge running short of toner is to be continuously used.

In an example of FIG. 5, the users A and B use the information processing apparatuses 101 and 102 respectively. The printing system 100 includes a storage unit for storing permission information indicating whether the toner cartridge running short of toner is continuously used for each user. A table 501 illustrates an example of the permission information.

Because the user A does not want a print of good quality even if shortage of toner is occurring in the toner cartridge of the printing apparatus 110, the user A selects the continuous use of the toner cartridge. The printing system 100 records information indicating that the user A selects the continuous use of the toner cartridge, in the table 501. In the table 501, “ON” indicates that the continuous use is performed and “OFF” indicates that the continuous use is not performed.

Because the user B wants a print of good quality, if shortage of toner occurs in the toner cartridge, the toner cartridge needs to be replaced. Therefore, the user B selects not to continuously use the toner cartridge running short of toner. The printing system 100 records information that the user B does not select the continuous use, in the table 501.

If shortage of toner is occurring in the toner cartridge of the printing apparatus 110, the printing system 100 refers to the table 510 to switch the apparatus status for each user and determine whether the toner cartridge is to be continuously used.

If the user A instructs the printing apparatus 110 to print and the information processing apparatus 101 transmits a print job to the printing apparatus 110, the printing apparatus 110 executes printing based on the print job even if a toner shortage is occurring in the printing apparatus 110. On the other hand, if the user B instructs the printing apparatus 110 to print, the information processing apparatus 102 transmits a print job to the printing apparatus 110, and the toner shortage occurs in the printing apparatus 110, the printing apparatus 110 interrupts printing based on the print job and executes recovery processing for recovering from a toner shortage. For example, there are displayed a message indicating that the toner shortage is occurring or a message urging to replace the toner cartridge running out of toner. The user B sees the message to replace the toner cartridge. After the toner cartridge is replaced, the printing apparatus 110 executes printing based on the print job.

Thus, the printing system 100 performs control for each user to determine whether to permit the toner cartridge running out of toner, to be continuously used. Thereby, whether the toner cartridge running out of toner, is to be continuously used can be switched for each user.

FIG. 6 illustrates a flow chart indicating a basic concept of a printing control executed by the printing system 100.

In step S601, the printing system 100 sets whether to continuously use the toner cartridge running short of toner for each user and manages contents of the setting in the table 501.

In step S602, when the user instructs the printing system 100 to print, in step S603, the printing system 100 determines whether the toner shortage is occurring in the toner cartridge of the printing apparatus 110. The toner shortage may occur before printing based on the print job is started or may occur while the printing is being executed. The determination made in step S603 includes determination made before the printing is started or while the printing is being executed. In step S603, the printing system 100 determines whether the toner shortage is occurring in the toner cartridge. The printing system 100 may determine whether the remaining amount of toner is less than a predetermined amount. That is to say, the printing system 100 determines whether the toner cartridge of the printing apparatus 110 lacks the toner, and proceeds to step S604 if it is determined that the toner cartridge lacks the toner.

If the toner shortage is not occurring (NO in step S603), the printing system 100 causes the printing system 100 to perform printing based on the print job. If the toner shortage is occurring (YES in step S603), in step S604, the printing system 100 determines whether the user who issues instructions for printing permits the continuous use of the toner cartridge. If the user permits the continuous use (YES in step S604), the printing system 100 causes the printing system 100 to perform printing based on the print job.

If the user does not permit the continuous use (NO in step S604), in step S605, the printing system 100 executes the recovery processing for recovering from the toner shortage. The user replaces the toner cartridge running short of toner. In step S606, after the toner cartridge is replaced, the printing system 100 causes the printing apparatus 110 to execute printing based on the print job.

Thereby, the printing system 100 can switch the apparatus status for each user and determine whether to continuously use the toner cartridge running short of toner.

[In a Case where the Printing System Manages Permission Information]

FIGS. 1 to 11 describe exemplary embodiments in which the printing apparatus manages the permission information.

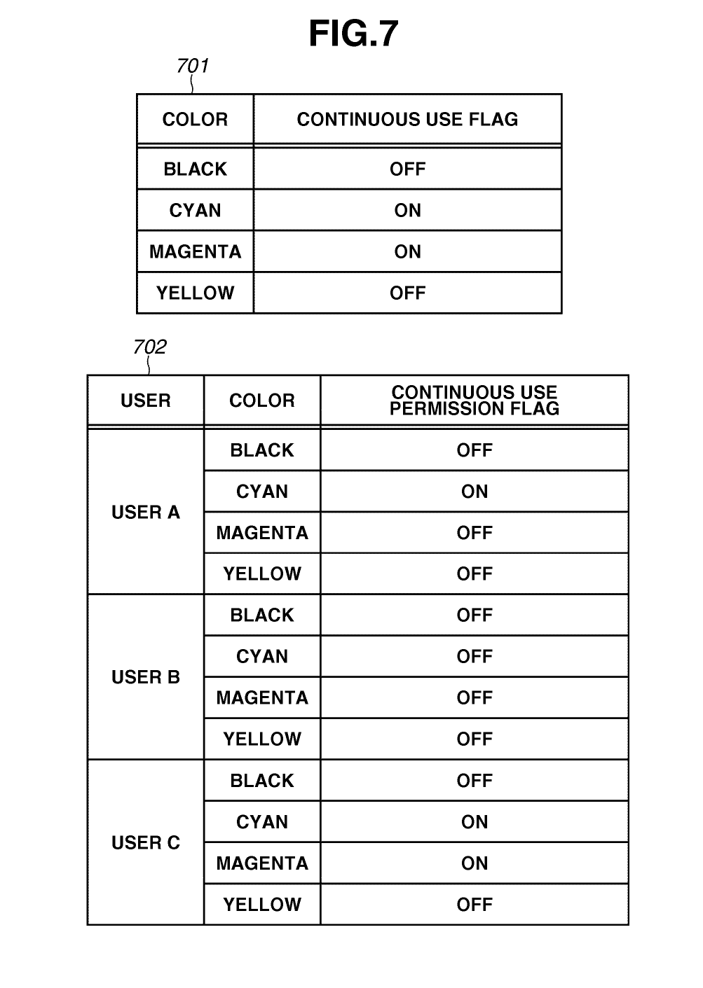

FIG. 7 illustrates a table 701 for managing a continuous use flag and a table 702 for managing a continuous use permission flag. The tables 701 and 702 are stored in the RAM 303. The tables 701 and 702 may be stored in the external storage apparatus 320 instead of the RAM 303.

In the present exemplary embodiment, the printing apparatus 110 executes color printing using four colors of black, cyan, magenta, and yellow.

The continuous use flag is setting information indicating whether the toner cartridge running short of toner is continuously used. If the continuous use flag is turned ON and the shortage of toner is occurring in the toner cartridge, the printing apparatus 110 continuously uses the toner cartridge without interrupting printing operations. On the other hand, if the continuous use flag is turned OFF and the shortage of toner is occurring in the toner cartridge, the printing apparatus 110 interrupts printing operations. The continuous use flag is prepared for each color.

For example, if the continuous use flag of a cyan toner cartridge is turned ON and the shortage of toner is occurring in the cyan toner cartridge, the printing apparatus 110 continuously uses the cyan toner cartridge without interrupting printing operations. If the continuous use flag of the cyan toner cartridge is turned ON and the shortage of toner is occurring in the black toner cartridge, the printing apparatus 110 interrupts printing operations. In this case, the printing apparatus 110 notifies the user that the shortage of toner is occurring in the black toner cartridge and inquires whether the user continuously uses the black toner cartridge.

The continuous use permission flag is a permission information indicating whether the toner cartridge running short of toner is permitted to be continuously used. If the continuous use flag is turned ON and the continuous use permission flag is also turned ON, the printing apparatus 110 continuously uses the toner cartridge without interrupting printing operations. On the other hand, if the continuous use flag is turned ON but the continuous use permission flag is turned OFF, the printing apparatus 110 determines that the toner cartridge is not permitted to be continuously used and interrupts printing operations. The continuous use permission flag is prepared for each color and each user. In the example of FIG. 7, the continuous use permission flags corresponding to users A, B, and C are prepared.

The reason both of the continuous use flag and the continuous use permission flag are provided in the present exemplary embodiment is that other users (a guest user, for example) except the users A, B, and C may use the printing apparatus 110. If the printing apparatus 110 receives a print job from the guest user, the printing apparatus 110 cannot refer to the continuous use permission flag corresponding to the guest user. Therefore, if the printing apparatus 110 receives a print job from the guest user, the printing apparatus 110 refers to only the continuous use flag to determine whether to continuously use the toner cartridge running short of toner.

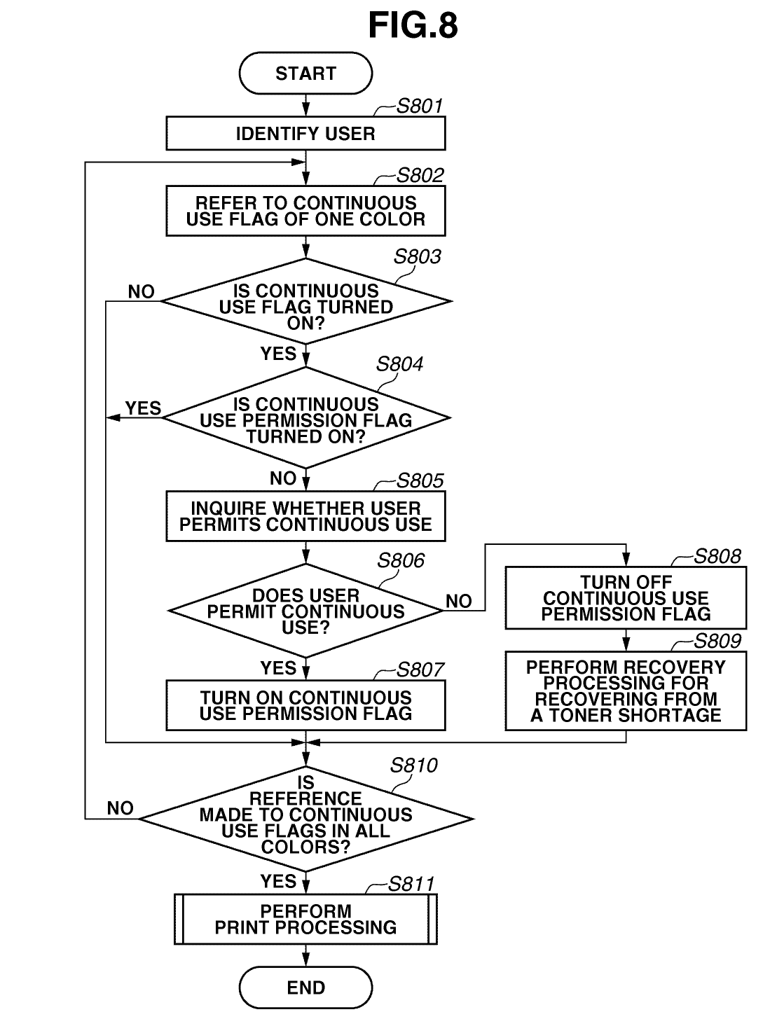

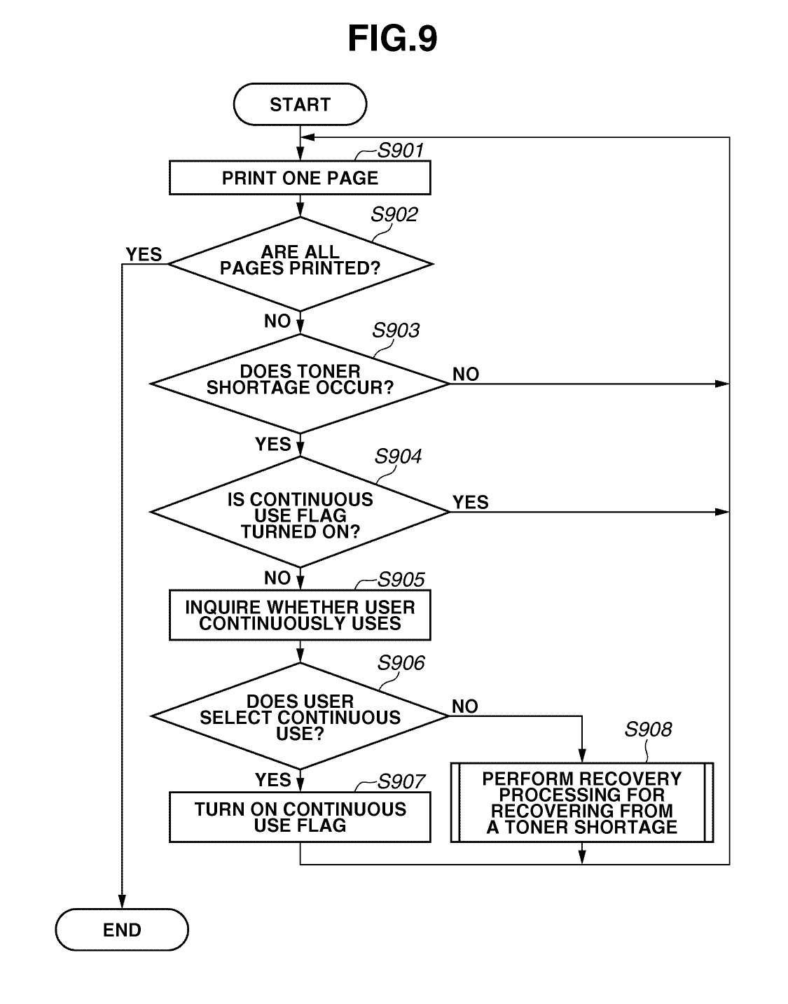

FIGS. 8 and 9 are flow charts illustrating the printing control executed by the printing apparatus 110. When the printing apparatus 110 receives a print job from the information processing apparatus 101 or 102, the control unit 301 starts the printing control illustrated in FIG. 8. The control unit 301 executes the control program based on the flow charts illustrated in FIGS. 8 and 9 to execute the following processing.

In step S801, when the print job is received, the control unit 301 acquires user identification information added to the print job to identify the user who issues instructions for printing based on the print job. The user identification information uses identification information (user ID, for example) allocated to each user and identification information (host ID, IP address, and others, for example) allocated to each information processing apparatus used by the user.

In step S802, the control unit 301 checks the table 701 to refer to the continuous use flag in one certain color. In step S803, the control unit 301 determines whether the continuous use flag is turned ON. If the continuous use flag is turned ON (YES in step S803), in step S804, the control unit 301 refers to the continuous use permission flag corresponding to the user identification information acquired in step S801 to determine whether the continuous use permission flag corresponding to the color whose continuous use flag is turned ON is turned ON.

If the continuous use permission flag is turned OFF (NO in step S804), in step S805, the control unit 301 inquires of the user whether the user permits the continuous use of the toner cartridge in the color whose continuous use flag is turned ON.

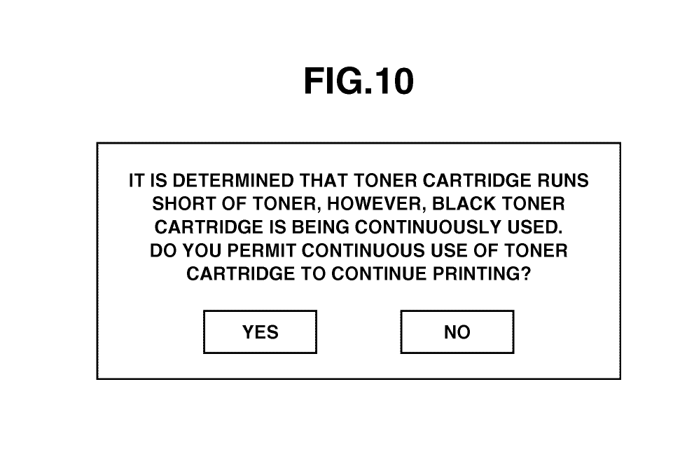

FIG. 10 is an example of a screen for inquiring whether the user permits the continuous use of the toner cartridge. The control unit 301 controls the display unit 306 to display the screen illustrated in FIG. 10. The user selects YES or NO using the control unit 305.

In step S806, the control unit 301 determines whether YES or NO is selected to determine whether the user permits the continuous use of the toner cartridge. If the user permits the continuous use of the toner cartridge (YES in step S806), in step S807, the control unit 301 turns ON the continuous use permission flag corresponding to the color whose continuous use flag is turned ON. On the other hand, if the user does not permit the continuous use of the toner cartridge (NO in step S806), in step S808, the control unit 301 turns OFF the continuous use permission flag and, in step S809, the control unit 301 executes the recovery processing for recovering from the toner shortage.

In the recovery processing, the control unit 301 controls the display unit 306 to display a message urging the replacement of the toner cartridge running short of toner and moves the toner cartridge running short of toner to a position where the toner cartridge can be replaced. The control unit 301 waits for the toner cartridge to be replaced and to be recovered from the toner shortage. When the toner cartridge is replaced and is recovered from the toner shortage, the control unit 301 proceeds to step S810.

In step S810, the control unit 301 determines whether the continuous use flags in all colors have been referred to. If there are the continuous use flags to which the control unit 301 has not yet referred (NO in step S810), in step S802, the control unit 301 refers next to the continuous use flags to which the control unit 301 has not yet referred. If the control unit 301 has referred to the continuous use flags in all colors (YES in step S810), in step S811, the control unit 301 executes the print processing illustrated in FIG. 9.

In step S805, the screen illustrated in FIG. 10 is displayed on the display unit 306. The screen illustrated in FIG. 10 may be displayed on the display device 240. In that case, the control unit 301 controls the communication control unit 307 to transmit state information indicating that the continuous use flag is turned ON and the continuous use permission flag is turned OFF, to the information processing apparatus. The state information is transmitted to the information processing apparatus that transmits the print job. When the status window 403 of the information processing apparatus receives the state information, the status window 403 displays the screen illustrated in FIG. 10 on the display device 240.

The status window 403 transmits a command to permit the continuous use of the toner cartridge or a command not to permit the continuous use of the toner cartridge to the printing apparatus 110. In step S806, the control unit 301 determines whether the user permits the continuous use of the toner cartridge according to the command.

FIG. 9 is a flow chart indicating the print processing executed in step S811.

In step S901, the control unit 301 analyzes the print job to cause the printer engine 308 to execute printing based on the print job. In the present exemplary embodiment, in step S901, the printer engine 308 executes printing page by page. In step S902, the control unit 301 determines whether all pages are printed. If all pages are printed (YES in step S902), the control unit 301 finishes the print processing.

If a page yet to be printed remains (NO in step S902), in step S903, the control unit 301 determines whether a toner shortage is occurring in any of cartridges of four colors. That is to say, the control unit 301 determines whether any of cartridges lacks the toner. If no toner shortage is occurring in any of the cartridges (NO in step S903), in step S901, the control unit 301 controls the printer engine 308 to print the next page.

In step S903, the control unit 301 checks only the occurrence of the toner shortage, but may check other causes for interruption. As factors other than the toner shortage, for example, when the user instructs temporary suspension of printing or cancellation of the print job using the operation unit 305, or a sheet jam occurs, the control unit 301 interrupts printing. In such cases, the control unit 301 executes processing according to the factors. The present exemplary embodiment focuses on the toner shortage, so that details about the case where printing is interrupted by factors other than the toner shortage are omitted.

If the toner shortage is occurring in any of the toner cartridges (YES in step S903), in step S904, the control unit 301 refers to the continuous use flag corresponding to the toner cartridge running short of toner to determine whether the continuous use flag is turned ON. If the continuous use flag is turned ON (YES in step S904), in step S901, the control unit 301 continues printing without causing the display unit 306 to display the toner shortage.

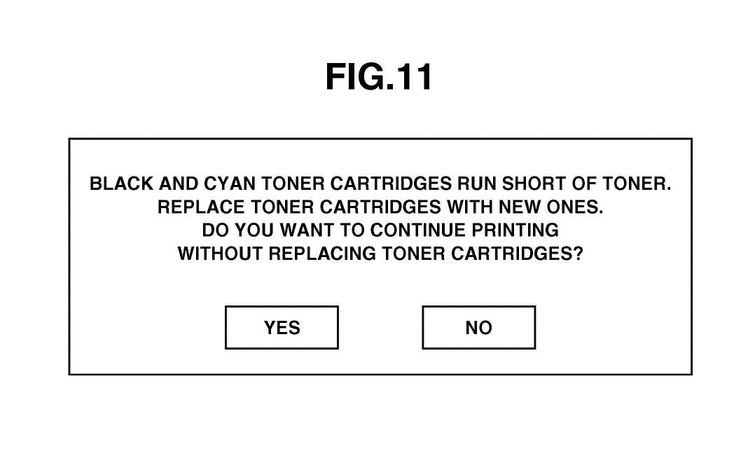

If the continuous use flag is turned OFF (NO in step S904), in step S905, the control unit 301 controls the display unit 306 to display a screen illustrated in FIG. 11 and inquires whether the user continuously uses the toner cartridge running short of toner.

FIG. 11 is an example of a screen for inquiring whether the user continuously uses the toner cartridge. The example of FIG. 11 indicates that the toner shortage is occurring in the toner cartridges of two colors and inquires whether the user continuously uses or replaces the toner cartridge. The user selects YES or NO using the operation unit 305.

In step S906, the control unit 301 determines whether YES or NO is selected to determine whether the user selects the continuous use of the toner cartridge. If the user selects the continuous use of the toner cartridge (YES in step S906), in step S907, the control unit 301 cancels an error display indicating the toner shortage and turns ON the continuous use flag corresponding to the toner cartridge running short of toner. In step S901, the control unit 301 controls the printer engine 308 to print the next page.

If the user does not select the continuous use of the toner cartridge (NO in step S906), in step S908, the control unit 301 executes the recovery processing for recovering a toner shortage.

In the recovery processing, the control unit 301 controls the display unit 306 to display a message urging the replacement of the toner cartridge running short of toner and moves the toner cartridge running short of toner to a position where the toner cartridge can be replaced. The control unit 301 waits for the toner cartridge to be replaced and to be recovered from the toner shortage. When the toner cartridge is replaced and is recovered from the toner shortage, in step S901, the control unit 301 controls the printer engine 308 to print the next page.

In step S905, the screen illustrated in FIG. 11 is displayed on the display unit 306. The screen illustrated in FIG. 11 may be displayed on the display device 240. In that case, the control unit 301 controls the communication control unit 307 to transmit state information indicating that the toner shortage is occurring, to the information processing apparatus. The state information is transmitted to the information processing apparatus that transmits the print job. When the status window 403 of the information processing apparatus receives the state information, the status window 403 displays the screen illustrated in FIG. 11 on the display device 240. The status window 403 transmits a command for the user to select the continuous use of the toner cartridge or a command for the user not to select the continuous use of the toner cartridge, to the printing apparatus 110. A command indicating the replacement of the toner cartridge may be transmitted instead of the command not to select the continuous use of the toner cartridge. In step S906, the control unit 301 determines whether the user selects the continuous use of the toner cartridge according to the command.

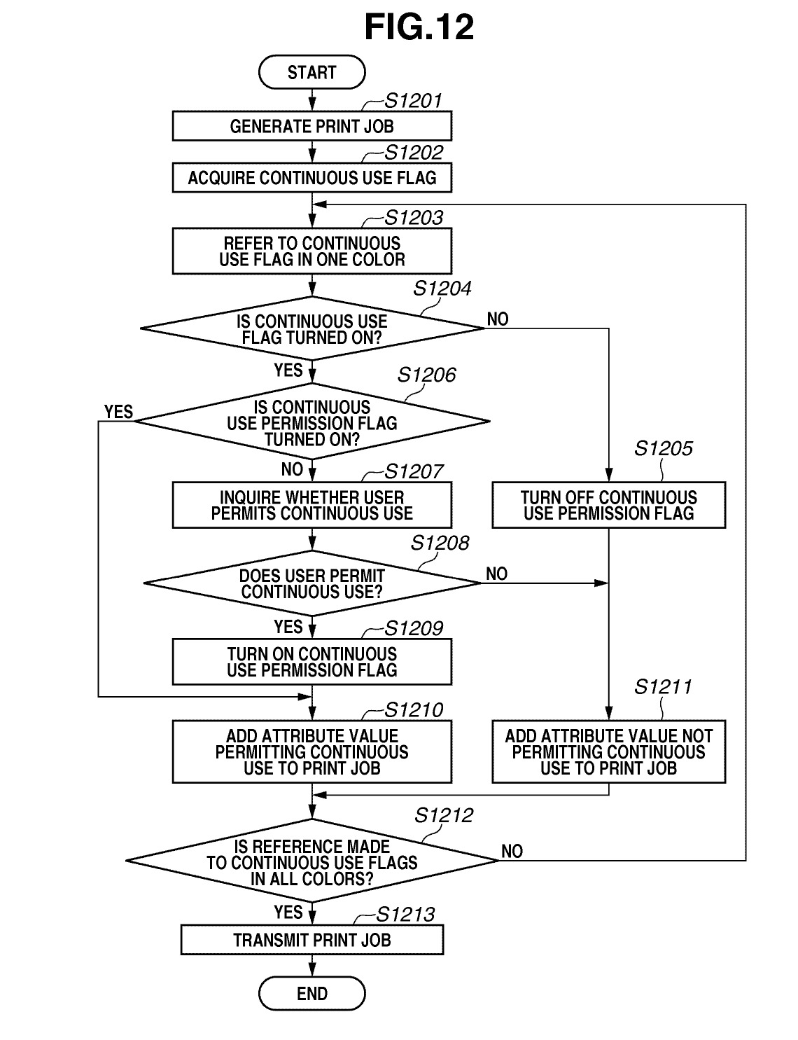

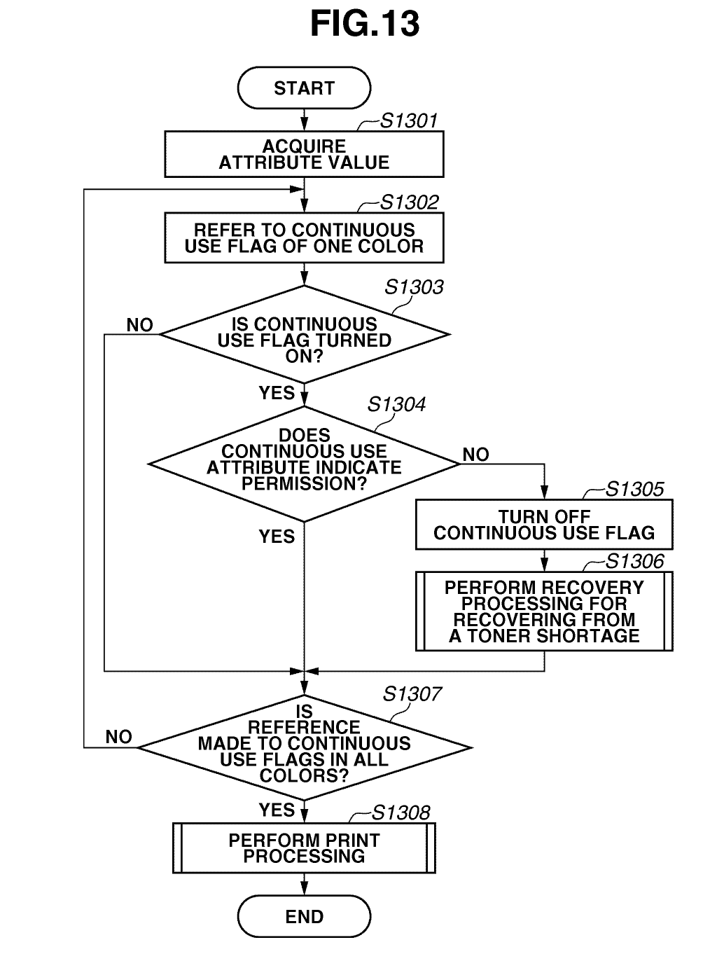

According to the present exemplary embodiment illustrated in FIGS. 8 and 9, the printing apparatus 110 can switch and determine for each user whether to continuously use the toner cartridge running short of toner. If the user permits or selects the continuous use, the user can avoid obtaining a print of the quality which the user does not want. The continuous use flag and the continuous use permission flag are provided for each color to enable a finer control regarding the continuous use of the toner cartridge.

[In a Case where the Information Processing Apparatus Manages Permission Information]FIGS. 12 to 13 describe exemplary embodiments in which the information processing apparatuses manage the permission information.

Also in the present exemplary embodiment, the printing apparatus 110 executes color printing using four colors of black, cyan, magenta, and yellow.

In the present exemplary embodiment, the table 701 for managing the continuous use flag is stored in the RAM 303 and the table 702 for managing the continuous use permission flag is stored in the external storage apparatus 220. The table 701 may be stored in the external storage apparatus 320 instead of in the RAM 303. The information processing apparatuses 101 and 102 manage the continuous use permission flag related to the user who uses the information processing apparatus. For example, if the user A uses the information processing apparatus 101 and the user B uses the information processing apparatus 102, the information processing apparatus 101 manages the continuous use permission flag corresponding to the user A. The information processing apparatus 102 manages the continuous use permission flag corresponding to the user B.

FIG. 12 is a flow chart illustrating the printing control processing executed by the information processing apparatus 101 or 102.

If the user issues instructions for printing by the application 401, the printer driver 402 starts the printing control processing illustrated in FIG. 12. As the hardware, the control unit 201 executes the program of the printer driver 402 to execute the printing control processing illustrated in FIG. 12.

In step S1201, the printer driver 402 provides the user with the user interface for print setting and generates a print job according to the print data received from the application 401 and the print setting.

In step S1202, the printer driver 402 communicates with the printing apparatus 110 via the communication control unit 207 to acquire the table 701 from the printing apparatus 110. In step S1203, the printer driver 402 checks the table 701 to refer to the continuous use flag of a certain color. In step S1204, the printer driver 402 determines whether the continuous use flag is turned ON.

If the continuous use flag is turned OFF (NO in step S1204), in step S1205, the printer driver 402 turns OFF the continuous use permission flag corresponding to the color of the continuous use flag. In step S1211, the printer driver 402 adds an attribute value indicating that the toner cartridge running short of toner is not permitted to be continuously used, to the print job as a continuous use attribute.

If the continuous use flag is turned ON (YES in step S1204), in step S1206, the printer driver 402 refers to the table 702 to determine whether the continuous use permission flag corresponding to the color whose continuous use flag is turned ON is turned ON.

If the continuous use permission flag is turned OFF (NO in step S1206), the printer driver 402 controls the display device 240 to display the screen illustrated in FIG. 10. Thereby, in step S1207, the printer driver 402 inquires whether the user permits the continuous use of the toner cartridge in the color whose continuous use flag is turned ON. The user selects YES or NO using the keyboard/mouse 230.

In step S1208, the printer driver 402 determines whether YES or NO is selected to determine whether the user permits the continuous use of the toner cartridge. If the user permits the continuous use of the toner cartridge (YES in step S1208), in step S1209, the printer driver 402 turns ON the continuous use permission flag corresponding to the color whose continuous use flag is turned ON. In step S1210, the printer driver 402 adds an attribute value indicating that the toner cartridge running short of toner is permitted to be continuously used, to the print job as the continuous use attribute.

If the user does not permit the continuous use of the toner cartridge (NO in step S1208), in step S1211, the printer driver 402 adds an attribute value indicating that the toner cartridge running short of toner is not permitted to be continuously used, to the print job as the continuous use attribute.

If the continuous use permission flag is turned ON (YES in step S1206), in step S1210, the printer driver 402 adds the attribute value indicating that the toner cartridge running short of toner is permitted to be continuously used, to the print job as the continuous use attribute.

In step S1212, the printer driver 402 determines whether the continuous use flags in all colors have been referred to. If there are the continuous use flags to which the printer driver 402 has not yet referred (NO in step S1212), in step S1203, the printer driver 402 refers next to the continuous use flags to which the printer driver 402 has not yet referred. If the printer driver 402 has referred to the continuous use flags in all colors (YES in step S1212), in step S1213, the printer driver 402 controls the communication control unit 207 to transmit the print job to the printing apparatus 110.

FIG. 13 is a flow chart illustrating the printing control processing executed by the printing apparatus 110. When the printing apparatus 110 receives the print job from the information processing apparatus 101 or 102, the control unit 301 starts the printing control processing illustrated in FIG. 13. The control unit 301 executes the control program based on the flow chart in FIG. 13 to execute the following processing.

When the printing apparatus 110 receives the print job, in step S1301, the control unit 301 analyzes the print job to acquire the attribute value added to the print job.

In step S1302, the control unit 301 checks the table 701 to refer to the continuous use flag of a certain color. In step S1303, the control unit 301 determines whether the continuous use flag is turned ON. If the continuous use flag is turned ON (YES in step S1303), in step S1304, the control unit 301 refers to the attribute value acquired in step S1301 to determine whether the attribute value corresponding to the color whose continuous use flag is turned ON indicates permission or non-permission.

If the attribute value indicates non-permission (NO in step S1304), in step S1305, the control unit 301 turns OFF the continuous use flag and, in step S1306, the control unit 301 executes the recovery processing for recovering from the toner shortage.

In the recovery processing, the control unit 301 controls the display unit 306 to display a message urging the replacement of the toner cartridge running short of toner and moves the toner cartridge running short of toner to a position where the toner cartridge can be replaced. The control unit 301 waits for the toner cartridge to be replaced and to be recovered from the toner shortage. When the toner cartridge is replaced and is recovered from the toner shortage, the control unit 301 proceeds to step S1307.

In step S1307, the control unit 301 determines whether the continuous use flags have been referred to in all colors. If there are the continuous use flags to which the control unit 301 has not yet referred (NO in step S1307), in step S1302, the control unit 301 refers next to the continuous use flags to which the control unit 301 has not yet referred. If the control unit 301 refers to the continuous use flags in all colors (YES in step S1307), in step S1308, the control unit 301 executes the print processing illustrated in FIG. 9.

According to the exemplary embodiments illustrated in FIGS. 12 and 13, the printing apparatus 110 can switch and determine for each user whether to continuously use the toner cartridge running short of toner. If the user permits or selects the continuous use, the user can avoid obtaining a print of the quality which the user does not want. The continuous use flag and the continuous use permission flag are provided for each color to enable a finer control regarding the continuous use of the toner cartridge.

[In a Case where Whether the Toner Cartridge is Continuously Used is Switched According to Print Quality]

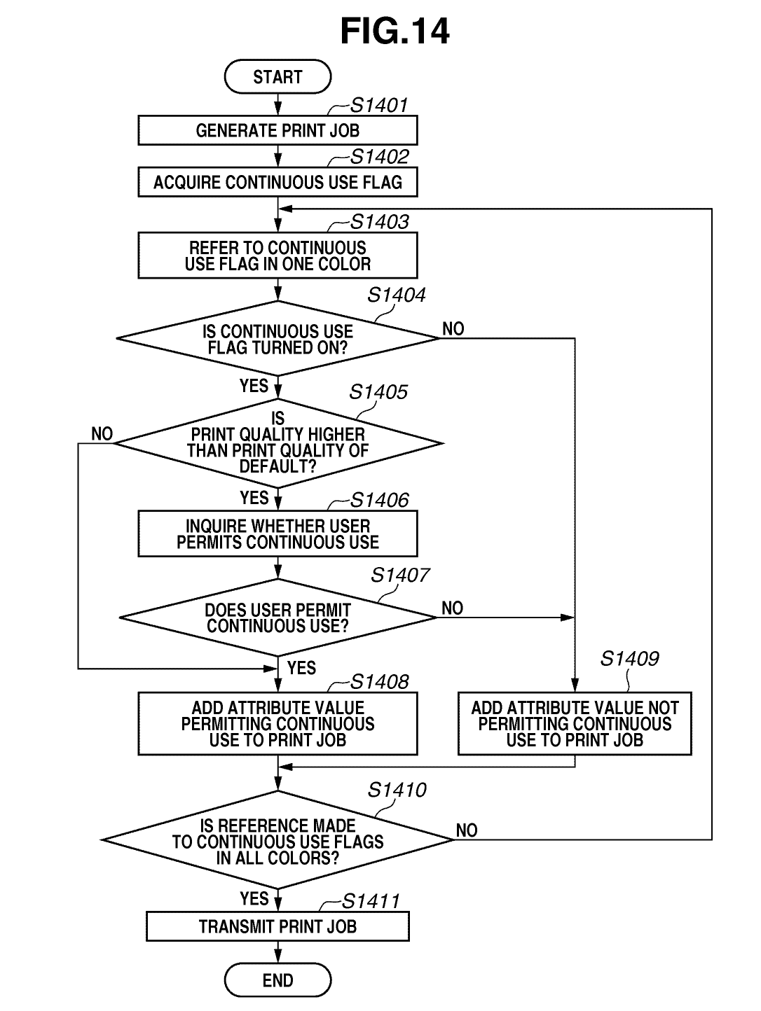

FIG. 14 describes an exemplary embodiment in which the information processing apparatuses 101 and 102 inquire whether the user permits the continuous use when the user performs the print setting for improving print quality without using the continuous use permission flag.

Also the present exemplary embodiment executes color printing using toners of black, cyan, magenta, and yellow.

Also in the present exemplary embodiment, the table 701 for managing the continuous use flag is stored in the RAM 303. On the other hand, the table 702 for managing the continuous use permission flag is not used. The table 701 may be stored in the external storage apparatus 320 instead of the RAM 303.

FIG. 14 is a flow chart illustrating the printing control processing executed by the information processing apparatus 101 or 102. The control unit 201 executes the control program based on the flow chart in FIG. 14 to execute the following processing.

If the user issues instructions for printing by the application 401, the printer driver 402 starts the printing control processing illustrated in FIG. 14. As the hardware, the control unit 201 executes the program of the printer driver 402 to execute the printing control processing illustrated in FIG. 14.

In step S1401, the printer driver 402 provides the user with the user interface for print setting and generates a print job according to the print data received from the application 401 and the print setting.

In step S1402, the printer driver 402 communicates with the printing apparatus 110 via the communication control unit 207 to acquire the table 701 from the printing apparatus 110. In step S1403, the printer driver 402 checks the table 701 to refer to the continuous use flag of a certain color. In step S1404, the printer driver 402 determines whether the continuous use flag is turned ON.

If the continuous use flag is turned OFF (NO in step S1404), in step S1409, the printer driver 402 adds an attribute value indicating that the toner cartridge running short of toner is not permitted to be continuously used, to the print job as the continuous use attribute.

If the continuous use flag is turned ON (YES in step S1404), in step S1405, the printer driver 402 determines whether the print quality specified by the user is higher than the print quality of default.

For example, in the user interface provided by the printer driver 402, the user selects also “desk top publishing (DTP) document” and “highly detailed document” from among “general document,” “DTP document,” and “highly detailed document.” In that case, it may be determined that the print quality specified by the user is higher than the print quality of default. Alternatively, if the user selects “color printing” from among “monochrome printing” and “color printing,” it may be determined that the print quality specified by the user is higher than the print quality of default.

If the print quality specified by the user is higher than the print quality of default (YES in step S1405), the printer driver 402 controls the display device 240 to display the screen illustrated in FIG. 10. Thereby, in step S1406, the printer driver 402 inquires whether the user permits the continuous use of the toner cartridge of the color whose continuous use flag is turned ON. The user selects YES or NO using the keyboard/mouse 230.

In step S1407, the printer driver 402 determines whether YES or NO is selected to determine whether the user permits the continuous use of the toner cartridge. If the user permits the continuous use of the toner cartridge (YES in step S1407), in step S1408, the printer driver 402 adds an attribute value indicating that the toner cartridge running short of toner is permitted to be continuously used, to the print job as the continuous use attribute.

If the user does not permit the continuous use of the toner cartridge (NO in step S1407), in step S1409, the printer driver 402 adds an attribute value indicating that the toner cartridge running short of toner is not permitted to be continuously used, to the print job as the continuous use attribute.

If the print quality specified by the user is not higher than the print quality of default (NO in step S1405), in step S1408, the printer driver 402 adds an attribute value indicating that the toner cartridge running short of toner is permitted to be continuously used, to the print job as the continuous use attribute.

In step S1410, the printer driver 402 determines whether the continuous use flags have been referred to in all colors. If there are the continuous use flags to which the printer driver 402 has not yet referred (NO in step S1410), in step S1403, the control unit 301 refers next to the continuous use flags to which the printer driver 402 has not yet referred. If the printer driver 402 has referred to the continuous use flags in all colors (YES in step S1410), in step S1411, the printer driver 402 controls the communication control unit 207 to transmit the print job to the printing apparatus 110.

When the printing apparatus 110 receives the print job from the information processing apparatus 101 or 102, the printing apparatus 110 executes the printing control processing illustrated in FIG. 13.

According to the exemplary embodiment illustrated in FIG. 14, each information processing apparatus inquires whether the user continuously uses the toner cartridge running short of toner according to a predetermined condition to allow switching and determining for each user whether the toner cartridge is to be continuously used.

If the print setting conforms to the predetermined condition such as high quality print job, it can be inquired whether the user continuously uses the toner cartridge running short of toner. This can prevent the toner cartridge from being automatically and continuously used irrespective of whether the user wants a high quality print. In the exemplary embodiment illustrated in FIG. 14, if the print quality specified by the user is higher than the print quality of default, the printer driver 402 controls the display device 240 to display the screen illustrated in FIG. 10. The printer driver 402 may inquire whether the user continuously uses the toner cartridge running short of toner, regardless of the print quality. If the user permits printing to be executed even if it is determined that the toner cartridge is running short of toner, the printer driver 402 adds the attribute value indicating that the toner cartridge running short of toner is permitted to be continuously used, to the print job as the continuous use attribute.

The exemplary embodiment enables one user to permit printing to be executed even if it is determined that the recording material is exhausted and the other user not to permit printing to be executed if the recording material is exhausted.

[Other Exemplary Embodiments]

The printing apparatus according to the present invention is not limited to a laser beam printer, but the present invention may be applied to a printing apparatus based on another printing system.

In the above description, the printing apparatus performs printing using toner as an example, however, the present invention is also applicable to a printing apparatus which performs printing using a recording material such as ink or toner.

A storing unit for storing the recording material may be a toner cartridge, an ink cartridge, or an ink tank.

In FIG. 15, the printing apparatus has toner cartridges of four colors. However, the present invention is also applicable to the printing apparatus which allows executing only monochrome printing and has only a black toner cartridge. In this case, the continuous use flag and the continuous use permission flag only for one color are prepared.

A method for supplying toner to recovering from toner shortage includes replenishing the toner cartridge with toner except for replacing the toner cartridge.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-272337, filed Dec. 13, 2012, which is hereby incorporated by reference herein in its entirety.

What is claimed is:

1. A printing system which performs printing using a recording material stored in a storing unit configured to store the recording material, the printing system comprising:
a printing unit configured to perform printing using the recording material stored in the storing unit;
a storage unit configured to store permission information indicating that a user permits printing to be executed even if it is determined that the storing unit lacks the recording material; and
a control unit configured to cause the printing unit to perform printing if it is determined that the storing unit lacks the recording material and the permission information indicating that the user who instructs printing permits printing to be executed is stored, wherein the control unit does not cause the printing unit to perform printing in a state where it is determined that the storing unit lacks the recording material, if it is determined that the storing unit lacks the recording material and the permission information indicating that the user who instructs printing permits printing to be executed is not stored.

2. The printing system according to claim 1, wherein storage unit stores the permission information indicating whether the user permits printing to be executed even if it is determined that the storing unit lacks the recording material for each of a plurality of users, and
the control unit determines whether printing is executed in a state where it is determined that the storing unit lacks the recording material based on the user who instructs printing, and the permission information stored in the storage unit.

3. The printing system according to claim 1, further comprising a display unit configured to display information,
wherein the control unit controls the display unit to display information indicating that the storing unit lacks the recording material or information urging the supply of the recording material if it is determined that the storing unit lacks the recording material and the permission information indicating that the user who instructs printing, permits printing to be executed, is not stored.

4. The printing system according to claim 1, wherein the control unit executes recovery processing for recovering from a state where the storing unit lacks the recording material by supplying the recording material if it is determined that the storing unit lacks the recording material and the permission information indicating that the user who instructs printing permits printing to be executed, is not stored.

5. The printing system according to claim 3, wherein the supply of the recording material includes the replacement of the storing unit or the replenishment of the storing unit with the recording material.

6. The printing system according to claim 1, further comprising a display unit configured to display information,
wherein the control unit controls the display unit to display information inquiring whether to permit printing to be executed even if the storing unit lacks the recording material, if it is determined that the storing unit lacks the recording material and the permission information indicating that the user who instructs printing permits printing to be executed, is not stored and
the control unit causes the storage unit to store the permission information indicating that the user who instructs printing, permits printing to be executed when the user who instructs printing, permits printing to be executed.

7. The printing system according to claim 1, further comprising a setting unit configured to set the apparatus to execute printing even if it is determined that the storing unit lacks the recording material, in a case where it is determined that the storing unit lacks the recording material,
wherein the storage unit further stores setting information indicating that printing is executed even if it is determined that the storing unit lacks the recording material and
the control unit does not execute printing if it is determined that the storing unit lacks the recording material, if the permission information indicating that the user who instructs printing, permits printing to be executed, is not stored even if the setting information is stored in the storage unit.

8. A printing apparatus which performs printing using a recording material stored in a storing unit configured to store the recording material, the printing apparatus comprising:
a printing unit configured to perform printing using the recording material stored in the storing unit;
a storage unit configured to store permission information indicating that a user permits printing to be executed even if it is determined that the storing unit lacks the recording material; and
a control unit configured to cause the printing unit to perform printing if it is determined that the storing unit lacks the recording material and the permission information indicating that the user who instructs printing permits printing to be executed, is stored, wherein the control unit does not cause the printing unit to perform printing in a state where it is determined that the storing unit lacks the recording material, if it is determined that the storing unit lacks the recording material and the permission information indicating that the user who instructs printing permits printing to be executed, is not stored.

9. The printing apparatus according to claim 8, wherein storage unit stores the permission information indicating that the user permits printing to be executed even if it is determined that the storing unit lacks the recording material, for each of a plurality of users, and
the control unit determines whether printing is executed in a state where it is determined that the storing unit lacks the recording material based on the user who instructs printing and the permission information stored in the storage unit.

10. The printing apparatus according to claim 8, further comprising a display unit configured to display information,
wherein the control unit controls the display unit to display information indicating that the storing unit lacks the recording material or information urging the supply of the recording material if it is determined that the storing unit lacks the recording material and the permission information indicating that the user who instructs printing permits printing to be executed, is not stored.

11. The printing apparatus according to claim 8, wherein the control unit executes recovery processing for recovering from a state where the storing unit lacks the recording material by supplying the recording material if it is determined that the storing unit lacks the recording material and the permission information indicating that the user who instructs printing permits printing to be executed, is not stored.

12. The printing apparatus according to claim 10, wherein the supply of the recording material includes the replacement of the storing unit or the replenishment of the storing unit with the recording material.

13. The printing apparatus according to claim 8, further comprising a display unit configured to display information,
wherein the control unit controls the display unit to display information inquiring whether to permit printing to be executed even if the storing unit lacks the recording material, if it is determined that the storing unit lacks the recording material and the permission information indicating that the user who instructs printing permits printing to be executed, is not stored and
the control unit causes the storage unit to store the permission information indicating that the user who instructs printing permits printing to be executed when the user who instructs printing permits printing to be executed.

14. The printing apparatus according to claim 8, further comprising a setting unit configured to set the apparatus to execute printing even if it is determined that the storing unit lacks the recording material, if it is determined that the storing unit lacks the recording material,
wherein the storage unit further stores setting information indicating that printing is executed even if it is determined that the storing unit lacks the recording material and
the control unit does not execute printing if it is determined that the storing unit lacks the recording material, if the permission information indicating that the user who instructs printing permits printing to be executed, is not stored even if the setting information is stored in the storage unit.

15. A printing apparatus which performs printing using a recording material stored in a storing unit for storing the recording material, the printing apparatus comprising:
a printing unit for performing printing using the recording material stored in the storing unit;
a storage unit for storing permission information indicating that a user permits printing to be performed even if it is determined that the storing unit lacks the recording material; and
a control unit for causing the printing unit to perform printing in a state where it is determined that the storing unit lacks the recording material, if the permission information corresponding to a user who instructs printing is stored, and performing control to move the storing unit to a replaceable position if it is determined that the storing unit lacks the recording material and the permission information corresponding to a user who instructs printing is not stored.

16. An information processing apparatus communicable with a printing apparatus which performs printing using a recording material, the information processing apparatus comprising:
a storage unit configured to store permission information indicating that a user permits printing to be executed even if it is determined that the printing apparatus lacks the recording material; and
a control unit configured to cause the printing apparatus to perform printing if it is determined that the printing apparatus lacks the recording material and the permission information indicating that the user who instructs printing permits printing to be executed, is stored, wherein the control unit does not cause the printing apparatus to perform printing in a state where it is determined that the printing apparatus lacks the recording material, if it is determined that the printing apparatus lacks the recording material and the permission information indicating that the user who instructs printing permits printing to be executed, is not stored.

17. An information processing apparatus communicable with a printing apparatus which performs printing using a recording material, the information processing apparatus comprising:
a determination unit configured to determine whether print setting conforms to a predetermined condition; and
a control unit configured to cause the printing apparatus to perform printing if it is determined that the printing apparatus lacks the recording material and the print setting does not conform to the predetermined condition, wherein the control unit does not cause the printing apparatus to perform printing in a state where it is determined that the printing apparatus lacks the recording material, if it is determined that the printing apparatus lacks the recording material and the print setting conforms to the predetermined condition.

18. An information processing apparatus communicable with a printing apparatus which performs printing using a recording material, the information processing apparatus comprising:
a determination unit for determining whether a user who instructs a print job permits printing to be performed even if it is determined that the printing apparatus lacks the recording material;
a transmitting unit configured to, if the determination unit determines that the user permits printing, transmit the print job instructing the printing apparatus to perform printing in a state where it is determined that the printing apparatus lacks the recording material, to the printing apparatus.

19. A printing control method for controlling printing in a printing apparatus which performs printing using a recording material, the printing control method comprising:
storing permission information indicating that a user permits printing to be executed even if it is determined that the printing apparatus lacks the recording material;
causing the printing apparatus to perform printing if it is determined that the printing apparatus lacks the recording material and the permission information indicating that the user who instructs printing permits printing to be executed, is stored; and
wherein the printing apparatus does not perform printing in a state where it is determined that the printing apparatus lacks the recording material, if it is determined that the printing apparatus lacks the recording material and the permission information indicating that the user who instructs printing permits printing to be executed, is not stored.

20. A printing control method for controlling printing in a printing apparatus which performs printing using a recording material, the printing control method comprising: p1 determining whether print setting conforms to a predetermined condition; and
causing the printing apparatus to perform printing if it is determined that the printing apparatus lacks the recording material and the print setting does not conform to the predetermined condition, the printing apparatus does not perform printing in a state where it is determined that the printing apparatus lacks the recording material, if it is determined that the printing apparatus lacks the recording material and the print setting conforms to the predetermined condition.

21. A recording medium storing a computer readable program, the program causing the computer to execute:
storing permission information indicating that a user permits printing to be executed even if it is determined that the printing apparatus lacks the recording material; and
causing the printing apparatus to perform printing if it is determined that the printing apparatus lacks the recording material and the permission information indicating that the user who instructs printing permits printing to be executed is, stored,
wherein the program does not cause the printing apparatus to perform printing in a state where it is determined that the printing apparatus lacks the recording material, if it is determined that the printing apparatus lacks the recording material and the permission information indicating that the user who instructs printing permits printing to be executed, is not stored.

22. A recording medium storing a computer readable program, the program causing the computer to execute:
determining whether print setting conforms to a predetermined condition; and
causing the printing apparatus to perform printing if it is determined that the printing apparatus lacks the recording material and the print setting does not conform to the predetermined condition,
wherein the program does not cause the printing apparatus to perform printing in a state where it is determined that the printing apparatus lacks the recording material, if it is determined that the printing apparatus lacks the recording material and the print setting conforms to the predetermined condition.
